(19) United States
(12) Patent Application Publication
(10) Pub. No.: US 2024/0055630 A1
(43) Pub. Date: Feb. 15, 2024

(54) FUEL-CELL SYSTEM WITH PROTECTION FROM ICING

(71) Applicant: Robert Bosch GmbH, Stuttgart (DE)

(72) Inventors: Helerson Kemmer, Vaihingen (DE); Jochen Braun, Heimsheim (DE)

(21) Appl. No.: 18/260,631

(22) PCT Filed: Dec. 16, 2021
(86) PCT No.: PCT/EP2021/086168

§ 371 Date: Jul. 7, 2023

(30) Foreign Application Priority Data
Jan. 11, 2021 (DE) 10 2021 200 148.3

(51) Int. Cl. H01M 8/04223; H01M 8/04082; H01M 8/0432

(52) U.S. Cl. CPC H01M 8/04253; H01M 8/04201; H01M 8/0432

(57) ABSTRACT

A fuel-cell system is proposed, comprising at least one fuel cell, an oxidant line, a hydrogen line, an exhaust-gas line, a control unit, and at least one electrically controllable valve, which is coupled to the control unit and is connected to one from among the oxidant line, the hydrogen line, and the exhaust-gas line. The fuel-cell system is distinguished in that the control unit is designed to activate the at least one valve in a pulsating or oscillating manner, at least during a first time interval, such that the at least one valve is prevented from remaining in a stationary state and seizing up by icing during the first time interval.

### BACKGROUND

The present invention relates to a fuel-cell system having at least one fuel cell and a method for operating a fuel-cell system.

Vehicles are known in which electrical power is supplied by a fuel-cell system, through which prime movers are supplied. Hydrogen with an oxidant, typically oxygen from ambient air, is catalytically connected to water, wherein electrical power is supplied. The ambient air is provided to a cathode path of the fuel cells by means of an air convection system or air compression system. The air flow in the cathode path also transports the water produced by the reaction in the form of water vapor or fluidly in droplet form. Oxygen-depleted wet cathode exhaust air is discharged to the environment via an exhaust-gas path. In most cases, purge gas and water are still introduced from an anode path into this exhaust-gas mass flow. The exhaust-gas path comprises actuators for valves, a turbine, or the like, as well as sensors for monitoring various parameters. All components must function and be started or stopped for the smooth operation of the fuel-cell system over the full operating range. This is a challenge, in particular, for vehicles with fuel-cell systems installed therein, because all globally relevant states and varying lengths of down-time of the vehicle must be considered, and at the same time corresponding lifetime specifications must be achieved. A critical starting case is, for example, the start of freezing at low temperatures below 0° C., as this can freeze reaction water created upon start-up as well as water thawed in the system at other points, and/or can condense and freeze moisture in the stopping phase and/or can freeze water in the system, and/or components can be subjected to ice formation and can become blocked.

### SUMMARY

It is therefore a problem addressed by the invention to propose a fuel cell or a fuel-cell system in which an improved protection against icing is achieved to cover all operational limits to be considered, wherein the complexity and costs of the fuel-cell system should preferably not increase significantly or not significantly for this purpose, while also meeting lifetime specifications.

A fuel-cell system is proposed, comprising at least one fuel cell, an oxidant line, an exhaust-gas line, a control unit, and at least one electrically controllable valve, which is coupled to the control unit and is connected to one from among the oxidant line and the exhaust-gas line. The fuel-cell system is distinguished in that the control unit is designed to activate the at least one valve in a pulsating or oscillating manner, at least during a first time interval, such that the at least one valve is prevented from remaining in a stationary state and seizing up by icing during the first time interval.

The at least one fuel cell could be a polymer electrolyte membrane (PEM) fuel cell. This is supplied with hydrogen or a gas comprising hydrogen on the anode side and with oxygen or a gas containing oxygen on the cathode side. During operation, water predominantly precipitates on the cathode, which enters the environment via the exhaust-gas line. Alternatively, other forms of fuel cells could be realized, which could include but are not limited to solid oxide and direct methanol fuel cells. As the oxidant, air could be suitable for operation in a vehicle, such that the oxidant line can in particular be an air line.

The at least one electrically controllable valve can relate to a plurality of different valves. For example, a supply valve for hydrogen or air and exhaust gas, shut-off valves, bypass valves, control valves, purge valves, and others are contemplated. These can be continuously adjustable depending on the intended use or can merely alternate between two discrete states.

The at least one valve, which is also perfused with water vapor or liquid water during operation, can consequently move in a pulsating or oscillating manner during the first time interval. The time duration for the pulsed operation can be limited to such a time in which a sufficient heating of the lines of the fuel-cell system is to be expected. The first interval should consequently cover all time points in which there is an actual icing hazard.

However, the pulsed operation of the at least one valve should not result in a restriction of the operation of the fuel-cell system. The pulsed activation is consequently to be tuned so that a certain movement of the at least one valve is carried out, which prevents a valve body from seizing up, but on average is always balanced around a desired setting value. The strength of the oscillation should still be only a small proportion of the control value, for example in a range of 1-15% of the specified control value.

The fuel-cell system according to the invention is consequently characterized by a highly effective protection against icing, which can be implemented without further components or parts. The complexity of the fuel-cell system does not increase as a result, but the operating range can be extended.

It is advantageous when the at least one valve comprises a switching valve and the control unit is designed to release the switching valve from a specified switching position by way of a pulsed activation signal and to assume the specified switching position after a specified pulse duration, wherein the pulse duration is shorter than an inertia-based duty cycle of the switching valve. The switching valve only has two discrete switching states, so that the valve in question is only designed to assume one of these two switching positions. By using a pulsed activation signal, a pulsed movement of the relevant valve can still be achieved while exploiting the inertia. When the valve is in an open position and the activation signal is directed to cause a closing, the valve is set into motion in order to achieve the closed position. However, significantly prior to reaching the closed position, the activation signal can be eliminated or replaced by an opposing activation signal, so that the valve is moved back into the open position. Depending on the pulse duration of the activation signal and the inertia of the relevant valve, the strength of the pulsating or oscillating movement of the valve can be influenced.

In an advantageous embodiment, the control unit is designed to continuously repeat the pulsed activation signal in the first time interval. By continuously repeating the pulsed activation signal, a pulsed movement of the relevant valve can be achieved over the first time interval.

In an advantageous embodiment, it can be provided that the at least one valve comprises a steady valve and the control unit is designed to activate the steady valve with an activation signal representing a specified open position, on which signal an oscillating auxiliary signal is up-modulated during the first time interval. The steady valve is provided for being able to assume continuous states, which are specified by a corresponding activation signal. The superimposition of an oscillating auxiliary signal consequently leads to the respective steady valve following this signal with a certain inertia.

It is further advantageous when the oscillating auxiliary signal is selected such that the steady valve oscillates around the specified opening position by a specified degree of opening proportion. The specified opening position is consequently maintained on average. However, by following the oscillating auxiliary signal, the seizing up of ice is prevented.

Preferably, the control unit is designed to interrupt the up-modulation of the auxiliary signal in case of transient specified opening position. If a transient open position is specified, the relevant valve is already moving. It is then also not necessary to up-modulate an additional oscillation. The lifetime of the actuator or a mechanical valve control can thus be increased, and the transient control is not disturbed, or the oscillating signal does not have to be considered here.

In a further advantageous embodiment, the control unit is designed to initiate the pulsating or oscillating activation in the presence of at least one parameter of a group of parameters comprising an ambient temperature of the fuel-cell system, at least one temperature within the fuel-cell system, a measure of a freezing potential, and an elapsing of a specified switch-on duty cycle. If such ambient states are found on the basis of which icing is not to be expected, it makes sense not to carry out a pulsating or oscillating activation in order to increase the lifetime.

Particularly advantageously, the control unit is designed to adjust limit parameters for the pulsating or oscillating activation on the basis of the pulsating or oscillating activation in first time intervals and at least one resulting temperature detected within the fuel-cell system during the preceding first time intervals. The control unit is consequently equipped with a self-learning function. In particular in connection with sensors that monitor temperatures inside the fuel-cell system, the control unit can carry out an estimate of whether there is a risk of icing after the elapsing of a plurality of first time intervals. Only if this is the case should a pulsating or oscillating activation be carried out.

The invention further relates to a method for operating a fuel-cell system having an oxidant line and an exhaust-gas line, wherein, according to the invention, the step of pulsating or oscillating activation of at least one electrically controllable valve connected to one among the oxidant line and the exhaust-gas line is provided in such a way that the at least one valve is prevented from remaining in a stationary state and seizing up by icing during the first time interval.

The method is characterized in that the pulsating or oscillating activation takes place around a specified opening position of the valve.

### BRIEF DESCRIPTION OF THE DRAWINGS

Shown are:

FIG. 1 a schematic illustration of the fuel-cell system.

FIG. 2 is a schematic representation of the activation signal.

FIG. 3 Aspects of a method for activation the fuel-cell system.

### DETAILED DESCRIPTION

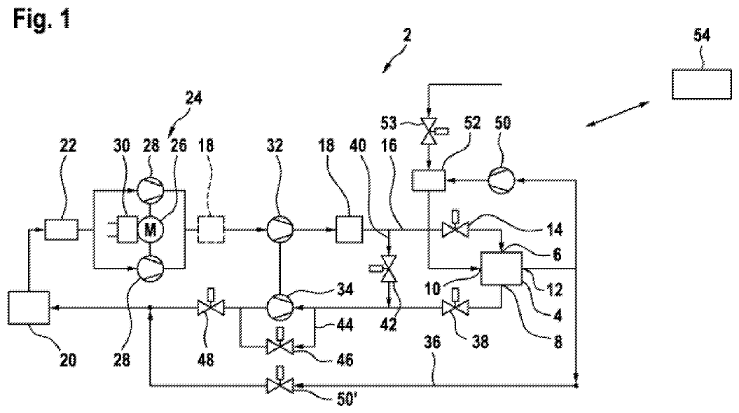

FIG. 1 shows a fuel-cell system 2 in a schematic illustration. The fuel-cell system 2 has a fuel cell 4 comprising an air input 6, an exhaust-gas output 8, a hydrogen input 10, and a hydrogen output 12. The air input 6 is connected to an oxidant line designed as an air line 16 via a first shut-off valve 14. The first shut-off valve 14 can allow for an air supply to the fuel cell 4 and can disrupt it as needed. An intercooler 18 cools compressed air before it enters the fuel cell 4. Air enters a pre-compressor 24 from the environment 20, for example by way of a particulate filter 22. It comprises, by way of example, two compressors 28 operated by an electric motor 26. The electric motor 26 can be supplied with electrical voltage via an inverter 30, which voltage is provided, for example, by the fuel cell 4. Optionally, a further intercooler 18 could be arranged downstream of pre-compressor 24. This is shown by a dashed line here, because it is not used in the embodiment example. Subsequently, there follows a second compressor 32, which conveys air to the intercooler 18 and consequently into the air line 16.

The second compressor 32 is powered by a turbine 34 coupled to an exhaust-gas line 36. The exhaust-gas line 36 is arranged downstream of the cathode outlet 8 via a second shut-off valve 38. A cathode by-pass 40 is provided by way of example between the air line 16 and the exhaust-gas line 36, which is selectively activatable via a first bypass valve 42. Also provided is a turbine bypass 44 which, as needed, bridges the turbine 34. It can be activated via a second bypass valve 46.

Furthermore, downstream of the turbine 34, a control valve 48 is arranged that directs the exhaust gas in a throttled manner to the environment 20 as needed. A purge valve 50′ is coupled to the anode outlet 12 and the exhaust-gas line 36. Furthermore, hydrogen present at the anode output 12 is recirculated to the anode input 10 via a third compressor 50 and a jet pump 52. Fresh hydrogen from a pressure tank, not shown, is mixed in via a throttle valve 53.

A control unit 54 is preferably coupled to all active elements, i.e., the valves 14, 38, 42, 46, 48, 50′ and 53 and the inverter 30, and is designed to activate the operation of the fuel-cell system by activating these components. As stated at the outset, it can be expected that icing effects can occur at temperatures below the freezing point due to the water vapor generated during the operation of the fuel-cell system 2. For example, the first shut-off valve 14, the second shut-off valve 38, the first bypass valve 42, the second bypass valve 46, and the control valve 48 and 50′ could be susceptible to icing-related blocking. The control unit 54 is now designed to activate at least one of these valves in a pulsating manner, at least during a first time interval, such that the at least one valve is prevented from remaining in a stationary state and seizing up by icing during the first time interval. This can be done in different ways, depending on the design of the particular valve.

For example, the first shut-off valve 14 and the second shut-off valve 38 are pure switching valves that can assume only two discrete states (opened, closed). Here, a pulsed activation signal is output by the control unit 54, which causes the respective exhaust valve 14 or 38 to exit an open position, for example. Based on the inertia, this requires a certain switching time depending on the design. The pulsed activation signal is now configured so that the activation signal is either canceled or replaced by an opposite signal significantly below this switching time of the valve in question. Based on the inertia, the valve now reverses the movement and moves back into the open state. The pulse duration of the activation signal can be sized such that the valve only moves between 90% and 100% of a fully open valve, for example. As a result, the relevant valve is oscillated, and a blocking by ice batch can be effectively avoided. The purge valve 50′ can be embodied as a clocked valve or as a steady valve.

The first bypass valve 42, the second bypass valve 46, and the control valve 48 can be steady valves. Here, the control unit 54 is designed to specify an open position to the valves 42, 46, and 48 with the aid of a corresponding activation signal. To prevent the freezing in a position that has been taken, the control unit 54 is now designed to superimpose an oscillating auxiliary signal on the corresponding activation signal. The valves 42, 46 and 48 consequently perform an oscillating movement about their specified open position and can thus prevent the ice from forming. The activation signal could be configured such that only a comparatively small deviation from a specified opening position is performed and on average corresponds to the opening position of the specified opening position.

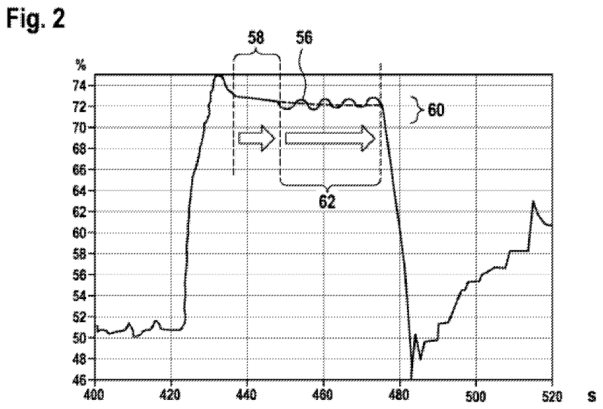

FIG. 2 shows an activation signal 56 caused by the control unit 54 to reach a specified open position, indicated in the Y-axis as the position of a valve actuator in %. After a switch-on duty cycle 58 or insistence cycle has elapsed, an oscillating auxiliary signal 60 is up-modulated on the control signal. This is repeated during a first time interval 62. As can be seen in FIG. 2, the open position remains substantially the same, but the relevant valve continuously moves a little in order to prevent freezing. Thereafter, the oscillating activation is lifted, because it is transient.

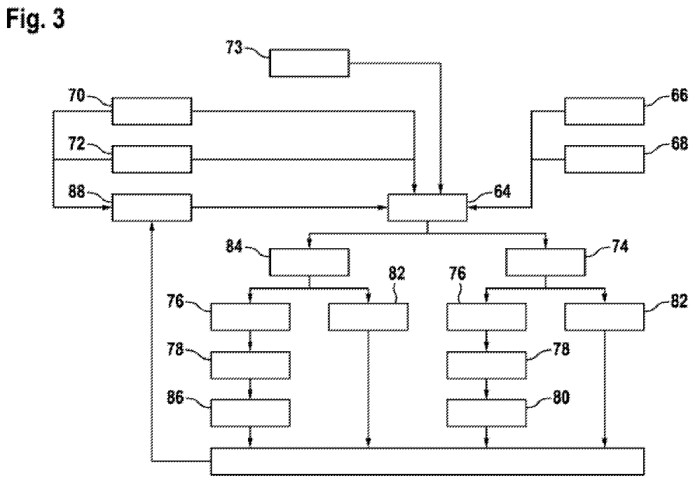

FIG. 3 shows a part of a method for operating a fuel-cell system 2. The focus here is on the anti-icing functions. The control unit 54 can perform a model-based estimate 64 to assess icing susceptibility. Historical vehicle data 66 can be considered, for example, including a stopping time, the state of the fuel-cell system 2 relative to a previous shutdown and drying, purging, or the like. Furthermore, historical weather data 68 could be retrieved from a network that would allow for detection of past environmental conditions. At the same time, control unit 54 can capture current vehicle data 70 and consider current weather data 72 and a mathematical model 73 of the fuel-cell system. Based on this data, a current icing hazard can be determined 64, which could necessitate a pulsating or oscillating activation. If such an icing hazard is present 74, the function of an actuator in a startup phase is checked 76, for example by monitoring a current characteristic in the activation. If this is not in proper order, an ice breakup function 78 is activated, which subsequently leads to the pulsating or oscillating activation behavior. Subsequently, corresponding thresholds and/or oscillation parameters in the database can be modified 80. However, if the actuator is functioning properly in the startup phase 82, the operation of the fuel-cell system 2 can continue.

If there is no icing hazard 84, it could also be checked in the startup phase 76 whether the function of an actuator is proper. Here, too, in the event of a fault, the ice breakup function 78 can be activated, if necessary, and an oscillation can be activated 86.

The model 73 can be adjusted 88 based on the assessment of the icing hazard and monitoring of temperatures in fuel-cell system 2.

1. A fuel-cell system (2), comprising at least one fuel cell (4) an oxidant line (16), an exhaust-gas line (36), a control unit (54), and at least one electrically controllable valve (14, 38, 42, 46, 48, 50′, 53), which is coupled to the control unit and is connected to one from among the oxidant line (16) and the exhaust-gas line (36), wherein the control unit (54) is configured to activate the at least one valve (14, 38, 42, 46, 48, 53) in a pulsating or oscillating manner, at least during a first time interval (62), such that the at least one valve (14, 38, 42, 46, 48, 53) is prevented from remaining in a stationary state and seizing up by icing during the first time interval (62).

2. The fuel-cell system (2) according to claim 1, wherein the at least one valve (14, 38, 42, 46, 48, 53) comprises a switching valve (14, 38) and the control unit (54) is configured to release the switching valve (14, 38) from a specified switching position by way of a pulsed activation signal (56) and to assume the specified switching position after a specified pulse duration, wherein the pulse duration is shorter than an inertia-based duty cycle of the switching valve (14, 38).

3. The fuel-cell system (2) according to claim 2, wherein the control unit (54) is configured to continuously repeat the pulsed activation signal (56) in the first time interval (62).

4. The fuel-cell system (2) according to claim 1, wherein the at least one valve (14, 38, 42, 46, 48, 53) comprises a steady valve (42, 46, 48, 53) and the control unit (54) is configured to activate the steady valve (42, 46, 48, 53) with an activation signal (56) representing a specified open position, on which signal an oscillating auxiliary signal (60) is up-modulated during the first time interval (62).

5. The fuel-cell system (2) according to claim 4, wherein the oscillating auxiliary signal (60) is selected such that the steady valve (42, 46, 48, 53) oscillates around the specified opening position by a specified degree of opening proportion.

6. The fuel-cell system (2) according to claim 4, wherein the control unit (54) is configured to interrupt the up-modulation of the auxiliary signal (60) in case of transient specified opening position.

7. The fuel-cell system (2) according to claim 1, wherein the control unit (54) is configured to initiate the pulsating or oscillating activation in the presence of at least one parameter of a group of parameters comprising:
ambient temperature of the fuel-cell system (2),
at least one temperature within the fuel-cell system (2),
a measure of a freezing potential, and
elapsing of a specified switch-on duty cycle (58).

8. The fuel-cell system (2) according to claim 1, wherein the control unit (54) is configured to adjust limit parameters for the pulsating or oscillating activation on the basis of the pulsating or oscillating activation in first time intervals (62) and at least one resulting temperature detected within the fuel-cell system (2) during the preceding first time intervals (62).

9. A method for operating a fuel-cell system (2) having an oxidant line (16) and an exhaust-gas line (36), the method comprising: of pulsating or oscillating activation of at least one electrically controllable valve (14, 38, 42, 46, 48, 53) connected to one among the oxidant line (16) and the exhaust-gas line (36) in such a way that the at least one valve (14, 38, 42, 46, 48, 53) is prevented from remaining in a stationary state and seizing up by icing during the first time interval (62).

10. The method according to claim 9, wherein the pulsating or oscillating activation takes place around a specified opening position of the valve (14, 38, 42, 46, 48, 53).
